(19) United States
(12) Patent Application Publication
(10) Pub. No.: US 2011/0066678 A1
(43) Pub. Date: Mar. 17, 2011

(54) WEBPAGE BROWSING SYSTEM, SERVER, WEBPAGE BROWSING METHOD, PROGRAM AND RECORDING MEDIUM FOR THE SAME

(75) Inventor: Hironori Yano, Tokyo (JP)

(73) Assignee: FUJIFILM Corporation, Tokyo (JP)

(21) Appl. No.: 12/880,980

(22) Filed: Sep. 13, 2010

(30) Foreign Application Priority Data
Sep. 14, 2009 (JP) JP 2009-212162

(51) Int. Cl. G06F 15/16

(52) U.S. Cl. 709/203

(57) ABSTRACT

The present invention can generate an image for webpage browsing that allows a webpage to be displayed in an optimum size at a portable terminal, and can also suppress communication costs as much as possible. A server acquires data of a webpage for which acquisition is requested from a portable terminal, renders the acquired webpage, and acquires a font size of characters in the webpage (step S15). The server receives a model name from the portable terminal, and acquires an optimum font size for the model of the portable terminal based on the received model name and a model name and optimum font size that are associated and stored in a memory. The server generates a browser image based on the font size of the webpage and the optimum font size (step S16), and transmits the browser image together with extracted link information (step S17) to the portable terminal (step S18).

### BACKGROUND OF THE INVENTION

1. Field of the Invention

The present invention relates to a webpage browsing system, a server, a webpage browsing method, a program and a recording medium for the same, and more particularly to a webpage browsing system, a server, a webpage browsing method, a program and a recording medium for the same that enable browsing of a webpage on a portable terminal.

2. Description of the Related Art

When attempting to display a webpage created for a PC (personal computer) on a portable terminal, in some cases the webpage is displayed on the portable terminal in a different form to the form in which the webpage is displayed on a PC. This is due to specification differences that are inherent to the kinds of web browsers installed in portable terminals.

To avoid this phenomenon, Japanese Patent Application Laid-Open No. 2004-220260 and Japanese Patent Application Laid-Open No. 2006-155333 propose methods in which a webpage is rendered and thereafter formed into an image on a server side, and the image is then transmitted as a response to a terminal together with link information in the image. The purpose of this technology is to absorb specification differences that are inherent to the kinds of web browsers that operate on portable terminals. As a result, a webpage creator can display a webpage on a portable terminal in the same condition as on a PC by creating only a webpage for a PC, and without creating a webpage that is dependent on the model of the mobile phone or the like.

### SUMMARY OF THE INVENTION

However, according to the inventions disclosed in Japanese Patent Application Laid-Open No. 2004-220260 and Japanese Patent Application Laid-Open No. 2006-155333, the amount of data to be communicated in order to display a page increases because an image is transmitted to a portable terminal, and there are thus the problems of a delay in displaying the page and of an increase in the communication charge. These problems become more noticeable as the compression rate of the image generated on the server is lowered or as the resolution of the image is increased.

Methods that can be considered in order to avoid an increase in communication costs include a method in which the image generated on the server is compressed at a high compression rate or a method in which the image is given a low resolution. However, when using these methods there is a problem that the image is difficult to view when displayed on a portable terminal due to the displayed characters being squashed and the like.

Further, according to the inventions disclosed in Japanese Patent Application Laid-Open No. 2004-220260 and Japanese Patent Application Laid-Open No. 2006-155333, there is the problem that because of differences among the specifications of display portions of portable terminals, the sizes of images that are displayed differ between portable terminals. For example, when displaying a webpage illustrated in FIG. 12A, depending on the portable terminal, a problem may occur whereby an image is displayed in which the characters are too large as shown in FIG. 12B or a problem may occur whereby an image is displayed in which the characters are too small as shown in FIG. 12C. In either case, the viewability is a problem since the image is not suitably displayed.

The present invention has been made in view of the above circumstances, and an object of the invention is to provide a webpage browsing system, a server, a webpage browsing method, a program and a recording medium for the same that can generate an image for webpage browsing that enables a webpage of an appropriate size to be displayed with a portable terminal and can also keep communication costs as low as possible.

A webpage browsing system according to a first aspect of the present invention has a portable terminal that includes a display device, and a server that is connected to the portable terminal, wherein: the portable terminal includes: a terminal-side transmission device which transmits information relating to the portable terminal to the server; a terminal-side reception device which receives an image that is transmitted from the server; and a display control device which causes the display device to display the image that is received by the terminal-side reception device; and the server includes: an acquisition device which acquires a webpage; an analyzing device which analyzes the webpage that is acquired by the acquisition device; a server-side reception device which receives the information relating to the portable terminal that is transmitted by the terminal-side transmission device; a storage device in which information relating to the portable terminal and an indicator that indicates a size of an optimum image are associated and stored; an image generation device which generates an image from the webpage acquired by the acquisition device based on an analysis result produced by the analyzing device, the information relating to the portable terminal that is received by the server-side reception device, and the information relating to the portable terminal and the indicator indicating a size of an optimum image that are associated and stored in the storage device; and a server-side transmission device which transmits the image generated by the image generation device to the portable terminal.

According to the webpage browsing system of the first aspect, a webpage is analyzed by a server. Information relating to a portable terminal that is transmitted from the portable terminal is received by the server. An image is generated from a webpage based on the received information, information relating to the portable terminal and an indicator indicating an optimum image size that are stored in a storage device, and a webpage analysis result. The generated image is transmitted from the server to the portable terminal, and the image is displayed by the portable terminal. It is thereby possible to generate an image for webpage browsing that makes it possible for a portable terminal to display a webpage in an appropriate size. Further, by transmitting an image that is displayable in an appropriate size from a server to a portable terminal, communication costs can be kept as low as possible since it is not necessary to transmit a needlessly large image.

A webpage browsing system according to a second aspect of the present invention is in accordance with the webpage browsing system of the first aspect, wherein: the portable terminal further includes an input device which, when a size of an image displayed by the display device is not appropriate, accepts input of a ratio of magnification or reduction of the size of the displayed image; the terminal-side transmission device transmits the ratio of magnification or reduction that is input by the input device to the server; the server-side reception device receives the ratio of magnification or reduction that is transmitted from the terminal-side transmission device; and the server further includes an updating device which updates the indicator that indicates a size of an optimum image that is stored in the storage device based on the ratio of magnification or reduction that is received by the server-side reception device.

According to the webpage browsing system of the second aspect, when input of a ratio of magnification or reduction for a size of an image that is displayed at a portable terminal is accepted, the input ratio of magnification or reduction is transmitted to the server. At the server, an indicator that indicates the size of an optimum image that is stored in the storage device is updated based on the received ratio of magnification or reduction. It is thereby possible to generate an image for webpage browsing of a more appropriate size.

A webpage browsing system according to a third aspect is in accordance with the webpage browsing system of the second aspect, wherein: the storage device associates and stores the ratio of magnification or reduction that is transmitted from the terminal-side transmission device and the information relating to the portable terminal; and when the ratio of magnification or reduction and the information relating to the portable terminal that are associated and stored in the storage device satisfy a predetermined criterion, the updating device updates the indicator that indicates a size of an optimum image that is stored in the storage device.

According to the webpage browsing system of the third aspect, at the server, the ratio of magnification or reduction that is received and information relating to the portable terminal are associated and stored, and when the ratio of magnification or reduction and the information relating to the portable terminal that are associated and stored satisfy a predetermined criterion, an indicator that indicates the size of an optimum image that is stored in the storage device is updated. When a model name is used as information relating to the portable terminal, if the predetermined criterion is satisfied, a ratio of magnification or reduction with respect to a predetermined model is updated. It is thereby possible to store an appropriate ratio of magnification or reduction for each item of information relating to a portable terminal, such as the model.

A webpage browsing system according to a fourth aspect is in accordance with the webpage browsing system of the first, second or third aspect, wherein: the terminal-side transmission device transmits information showing a model of the portable terminal or information that is unique to the portable terminal as the information relating to the portable terminal; the server-side reception device receives the information showing the model of the portable terminal or the information that is unique to the portable terminal that is transmitted by the terminal-side transmission device; the storage device associates and stores information showing the model of the portable terminal or information that is unique to the portable terminal and a size of characters (hereunder, referred to as “appropriate font size”) in an image that is displayed in an optimum size by the portable terminal; the analyzing device acquires a font size of the acquired webpage; and the image generation device includes: a device which acquires an appropriate font size with respect to the portable terminal based on the information showing the model of the portable terminal or the information that is unique to the portable terminal that is received by the server-side reception device, and the information showing the model of the portable terminal or the information that is unique to the portable terminal that is stored in the storage device; a device which converts a size of the webpage so that the font size acquired by the analyzing device becomes the appropriate font size with respect to the portable terminal; and a device which converts the webpage, whose size has been converted, to generate an image.

According to the webpage browsing system of the fourth aspect, information showing the model of the portable terminal or information that is unique to the portable terminal is transmitted from the portable terminal to the server as information relating to the portable terminal. In the server, the information showing the model of the portable terminal or information that is unique to the portable terminal and a size of characters (hereunder, referred to as “appropriate font size”) in an image that is displayed in an optimum size by the portable terminal are associated and stored in the storage device. At the server, the appropriate font size with respect to the portable terminal is acquired based on the information showing the model of the portable terminal or information that is unique to the portable terminal that is transmitted from the portable terminal and information showing the model of the portable terminal or information that is unique to the portable terminal that is stored in the storage device, the size of the webpage is changed so that a font size of the webpage that has been analyzed by the analyzing device becomes an appropriate font size with respect to the portable terminal, and the webpage whose size has been converted is converted into an image. It is thereby possible to generate an image for webpage browsing of an optimum size using the font size as a criterion.

A webpage browsing system according to a fifth aspect of the present invention is in accordance with the webpage browsing system of any one of the first to fourth aspects, wherein the analyzing device analyzes whether or not an object is included in the webpage; and the server further includes: a link information extraction device which, when a result of analysis by the analyzing device indicates that an object is included, extracts link information to the object, and a size conversion ratio calculation device which calculates a size conversion ratio based on the font size acquired by the analyzing device and the appropriate font size for the portable terminal; wherein the server-side transmission device transmits the image generated by the image generation device, the link information extracted by the link information extraction device, and the size conversion ratio calculated by the size conversion ratio calculation device to the portable terminal; and the display control device causes the object to be displayed in an optimum size overlapping the image based on the link information and the size conversion ratio.

According to the webpage browsing system of the fifth aspect, at the server an analysis is performed regarding whether or not an object is included in a webpage, and when the analysis result indicates that an object is included, link information to the object is extracted. Further, at the server, a size conversion ratio is calculated based on the font size of the webpage that is analyzed by the analyzing device and an appropriate font size with respect to the portable terminal, and the image, link information, and size conversion ratio are transmitted from the server to the portable terminal. At the portable terminal, the object is displayed in an optimum size overlapping the image based on the link information and the size conversion ratio. It is thereby possible to browse a webpage with a portable terminal in the same manner as with a PC.

A webpage browsing system according to a sixth aspect of the present invention is in accordance with the webpage browsing system of any one of the first to fifth aspects, wherein: the storage device associates and stores information relating to the portable terminal, an indicator that indicates a size of an optimum image, and a compression ratio of an image with respect to the portable terminal; the server further includes a compression device which acquires the compression ratio based on the information relating to the portable terminal that is received by the server-side reception device, and compresses the image that is generated by the image generation device using the compression ratio; and the server-side transmission device transmits the image that is compressed by the compression device.

According to the webpage browsing system of the sixth aspect, an image generated by the image generation device is compressed using a compression ratio for the portable terminal, and the image after compression is transmitted to the portable terminal. It is thereby possible to reduce by a maximum the amount of transmitted data. Consequently, the communication cost can be suppressed as much as possible.

A server according to a seventh aspect of the present invention is included in a webpage browsing system according to any one of the first to sixth aspects.

A webpage browsing method according to an eighth aspect of the present invention includes: a step of receiving information relating to a portable terminal from the portable terminal; a step of acquiring an indicator that indicates a size of an optimum image with respect to the portable terminal based on the information relating to the portable terminal that is received and information relating to a portable terminal and an indicator that indicates a size of an optimum image that are associated and stored in a storage device; a step of acquiring a webpage; a step of analyzing the acquired webpage; a step of generating an image from the acquired webpage based on a result of analysis of the webpage and the acquired indicator that indicates a size of an optimum image with respect to the portable terminal; and a step of transmitting the generated image to the portable terminal.

A program according to a ninth aspect of the present invention causes an arithmetic apparatus to execute a webpage browsing method according to the eighth aspect.

According to a tenth aspect of the present invention, code of the program according to the ninth aspect is stored in a recording medium, and the code is readable by the arithmetic apparatus.

According to the present invention, it is possible to generate an image for webpage browsing such that a webpage can be displayed in an optimum size with a portable terminal, and also suppress a communication cost as much as possible.

### BRIEF DESCRIPTION OF THE DRAWINGS

FIG. 1 is a schematic diagram of a webpage browsing system 1 to which the present invention is applied;

FIG. 2 is a view that illustrates an example of a terminal information table;

FIG. 3 is a view that illustrates an example of an image conversion table;

FIG. 4 is a flowchart that illustrates a flow of processing with which the server of the webpage browsing system 1 acquires portable terminal information of a portable terminal;

FIG. 5 is a flowchart that illustrates a flow of processing with which the webpage browsing system 1 generates a browser image;

FIGS. 6A and 6B are views that illustrate an example of a webpage and an example of a browser image display, respectively;

FIG. 7 is a schematic diagram of a webpage browsing system 2 to which the present invention is applied;

FIG. 8 is a view that illustrates an example of a terminal-unique information table;

FIG. 9 is a flowchart that illustrates a flow of processing with which the server updates the terminal-unique information table;

FIG. 10 is a flowchart that illustrates a flow of processing with which the webpage browsing system 2 generates a browser image;

FIG. 11 is a flowchart that illustrates a flow of processing with which the server of the webpage browsing system 2 updates the image conversion table; and

FIGS. 12A, 12B, and 12C are views that illustrate an example of a webpage, a conventional example in which an image is displayed in which the characters are too large, and a conventional example in which an image is displayed in which the characters are too small, respectively.

### DETAILED DESCRIPTION OF THE PREFERRED EMBODIMENTS

### First Embodiment

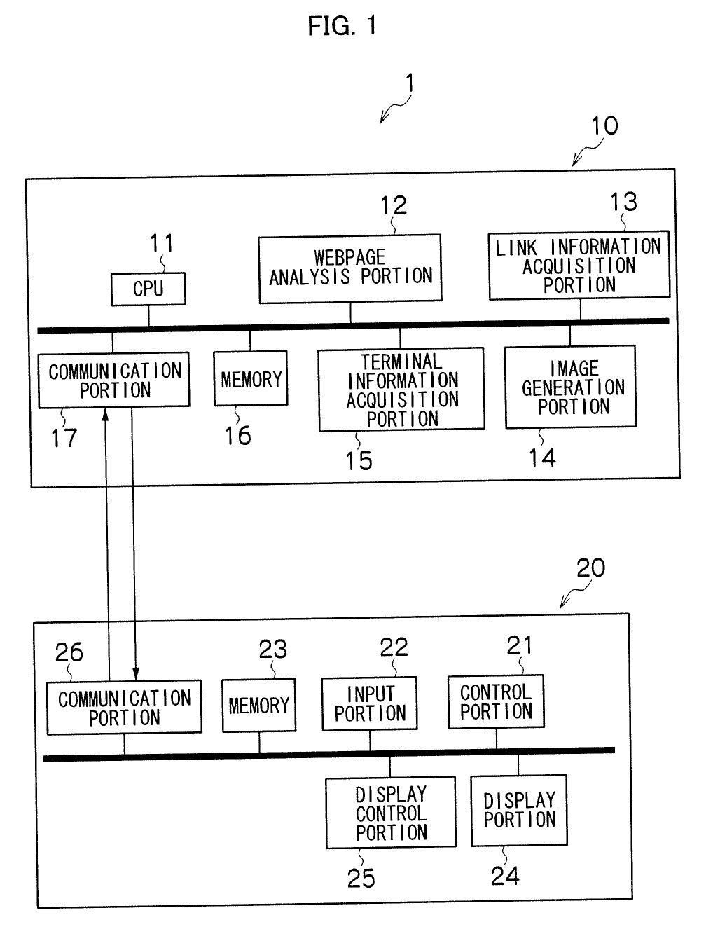

FIG. 1 is a schematic diagram of a webpage browsing system 1 to which the present invention is applied. As shown in FIG. 1, the webpage browsing system 1 mainly includes a server 10 and a portable terminal 20. One portable terminal 20 or a plurality of portable terminals 20 may be connected to the server 10.

As shown in FIG. 1, the server 10 mainly includes a CPU 11, a webpage analysis portion 12, a link information acquisition portion 13, an image generation portion 14, a terminal information acquisition portion 15, a memory 16, and a communication portion 17.

The CPU 11 functions as a control device that performs unified control of the entire operations of the server 10, and also functions as an arithmetic device that performs various kinds of arithmetic processing. The CPU 11 has a memory region that stores firmware as a control program, a browser as a program for displaying a webpage, and various kinds of data necessary for control and the like. Further, the CPU 11 has a memory region that is utilized as a working area of the CPU 11 and also as a temporary storage region of image data for display and the like.

The CPU 11 is connected to the Internet (unshown), and acquires various kinds of data such as a webpage URL or a HTML file that is requested from the portable terminal 20 via the Internet.

The webpage analysis portion 12 analyzes a HTML file of a webpage acquired by the CPU 11. For example, the webpage analysis portion 12 acquires information regarding the size of characters based on a size attribute of a font tag or a CSS font-size property.

The link information acquisition portion 13 analyzes tags of the HTML file of a webpage acquired by the CPU 11 to extract a link included in the webpage. The link information acquisition portion 13 also extracts an object such as an image file included in the webpage by analyzing the tags of the HTML file, and extracts a link to the object.

The image generation portion 14 generates an image (hereunder, referred to as “browsing image”) from the webpage acquired by the CPU 11 based on an analysis result of the webpage analysis portion 12 and an image conversion table (described in detail later) stored in the memory 16. The image generation portion 14 stores the generated browsing image in a memory region of the CPU 11.

The terminal information acquisition portion 15 determines the model of the portable terminal 20 based on the portable terminal information transmitted from the portable terminal 20.

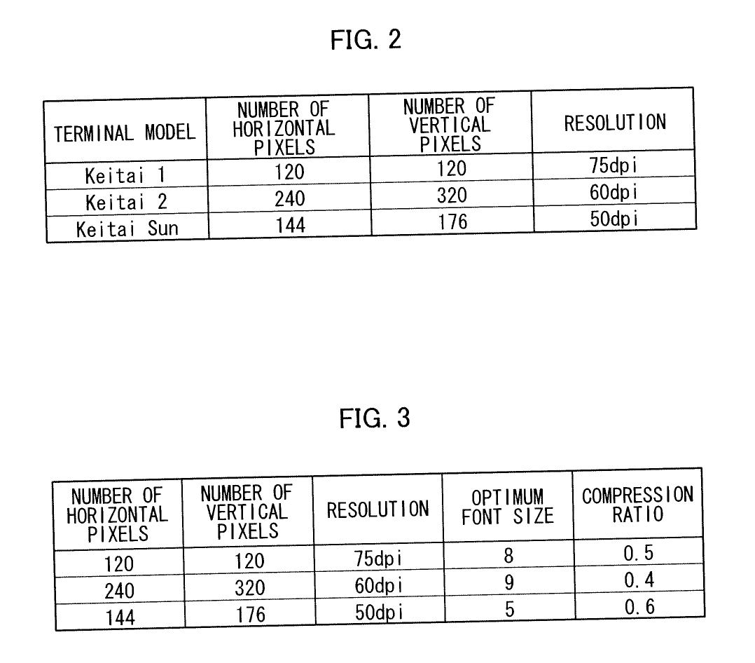

The memory 16 stores a terminal information table and an image conversion table. As shown in FIG. 2, portable terminal information (for example, model name, terminal-unique ID, or user ID) of portable terminals and information relating to the display portion (number of horizontal pixels, number of vertical pixels, resolution) of the portable terminals are associated and registered in the terminal information table. As shown in FIG. 3, information relating to the display portion of the portable terminal, an optimum font size, and a compression ratio are associated and registered in the image conversion table.

The information relating to a display portion of a portable terminal is information concerning the capability of the display portion such as the number of vertical pixels, the number of horizontal pixels, the resolution (dpi), and the capacity with respect to reproducible images. In FIGS. 2 and 3, the number of vertical pixels, number of horizontal pixels, and resolution are shown as examples thereof. The term “optimum font size” refers to the size of characters included in an image when the image is displayed in the optimum size on the display portion of a certain portable terminal. The term “compression ratio” refers to an optimum compression ratio that allows a browsing image to be viewed without difficulty on the portable terminal 20 that is used when compressing a browsing image and transmitting the compressed browsing image to the portable terminal 20. A Q value used for JPEG compression may be mentioned as an example thereof. In this connection, a configuration may also be adopted that transmits a browsing image to the portable terminal 20 without compressing the browsing image, and in that case a compression ratio is not required.

The communication portion 17 receives portable terminal information and a webpage browsing request and the like that are transmitted from the portable terminal 20.

The portable terminal 20 is, for example, a mobile phone, and is connected to the server 10 via a network. As shown in FIG. 1, the portable terminal 20 mainly includes a control portion 21, an input portion 22, a memory 23, a display portion 24, a display control portion 25, and a communication portion 26. Since other components and functions of the portable terminal 20 are already known, a description of those components is omitted here.

The control portion 21 performs unified control of the entire operations of the portable terminal 20, and also functions as an arithmetic device that performs various kinds of arithmetic processing. The control portion 21 has a memory region that stores portable terminal information of the portable terminal 20 and programs necessary for various kinds of control.

The input portion 22 allows a user to input various instructions, and includes a ten-key keypad, cross keys, a call button or the like.

The memory 23 stores portable terminal information of the portable terminal 20.

The display portion 24 is a liquid crystal display that is capable of a color display. The display portion 24 is not limited to a liquid crystal display, and an organic EL or the like may be used.

The display control portion 25 causes an initial screen that has been transmitted from the server 10 to be displayed on the display portion 24. The display control portion 25 also executes an application that has been transmitted from the server 10, and causes image data that has been transmitted from the server 10 to be displayed on the display portion 24.

The communication portion 26 receives a browser image and the like that has been transmitted from the server 10.

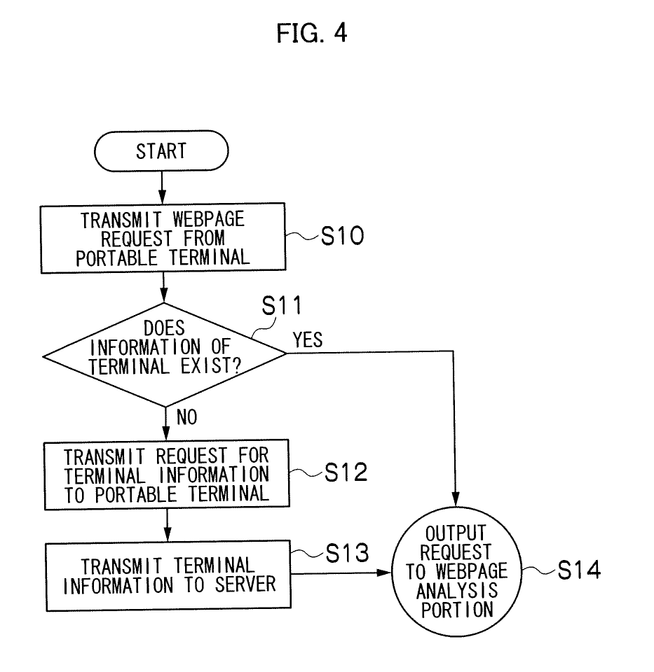

The operations of the webpage browsing system 1 that is configured as described above will now be described. FIG. 4 is a flowchart that illustrates a flow of processing with which the server 10 acquires portable terminal information of the portable terminal 20.

The control portion 21 of the portable terminal 20 transmits an acquisition request for a webpage which the user wishes to browse to the server 10. At that time, the control portion 21 also transmits portable terminal information of the portable terminal 20 to the server 10 (step S10). According to the present embodiment, the control portion 21 transmits the model name as the portable terminal information.

The CPU 11 of the server 10 receives the acquisition request and portable terminal information, and determines whether or not the portable terminal information that is transmitted from the portable terminal 20 in step S10 is stored in the terminal information table (step S11).

If the portable terminal information that is transmitted from the portable terminal 20 in step S10 is not stored in the terminal information table (No in step S11), the CPU 11 transmits a request to send information relating to the display portion of the portable terminal 20 to the portable terminal 20 (step S12).

The control portion 21 receives the request from the CPU 11, and transmits the portable terminal information and information relating to the display portion of the portable terminal 20 to the server 10. Upon receiving this information, the CPU 11 associates the portable terminal information and the information relating to the display portion of the portable terminal 20, and stores the information in the terminal information table. The CPU 11 also determines whether an optimum font size and a compression ratio that are associated with the information relating to the display portion of the portable terminal 20 are stored in the image conversion table. If an optimum font size and a compression ratio that are associated with the information relating to the display portion of the portable terminal 20 are not stored in the image conversion table, the CPU 11 associates an optimum font size and a compression ratio that are associated with information that is closest to information relating to the display portion of the portable terminal 20 that is stored in the image conversion table to the information relating to the display portion of the portable terminal 20, and stores the associated information in the image conversion table (step S13).

Thereafter, the CPU 11 acquires data of the webpage for which acquisition is requested in step S10, and outputs an analysis request to the webpage analysis portion 12 (step S14).

If portable terminal information that has been transmitted from the portable terminal 20 in step S10 is stored in the terminal information table (Yes in step S11), the CPU 11 outputs an analysis request to the webpage analysis portion 12 (step S14).

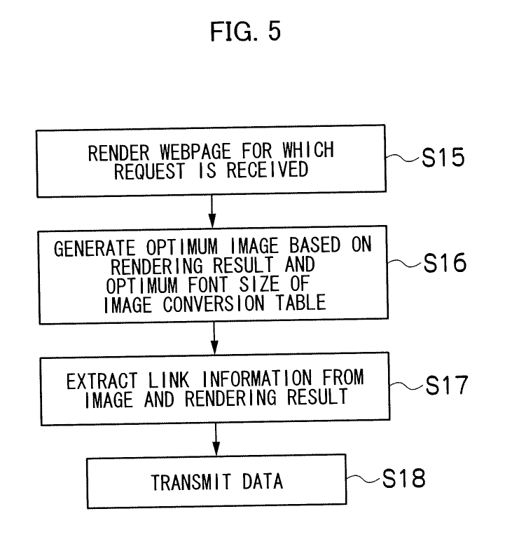

FIG. 5 is a flowchart that illustrates a flow of processing that generates a browser image. This processing is performed after the CPU 11 outputs an analysis request to the webpage analysis portion 12 (step S14).

The CPU 11 acquires data of the webpage for which acquisition is requested in step S10, and outputs the data to the webpage analysis portion 12, the link information acquisition portion 13, and the image generation portion 14. The webpage analysis portion 12 performs rendering with respect to the webpage for which an acquisition request has been transmitted in step S10 (step S15). When a normal web browser that is used with a PC or the like performs rendering to display a webpage, the size of characters is decided at this stage. However, according to the present embodiment, only information regarding the size of characters of the webpage is acquired, and the size of characters is not decided. The webpage analysis portion 12 outputs the result of rendering to the image generation portion 14.

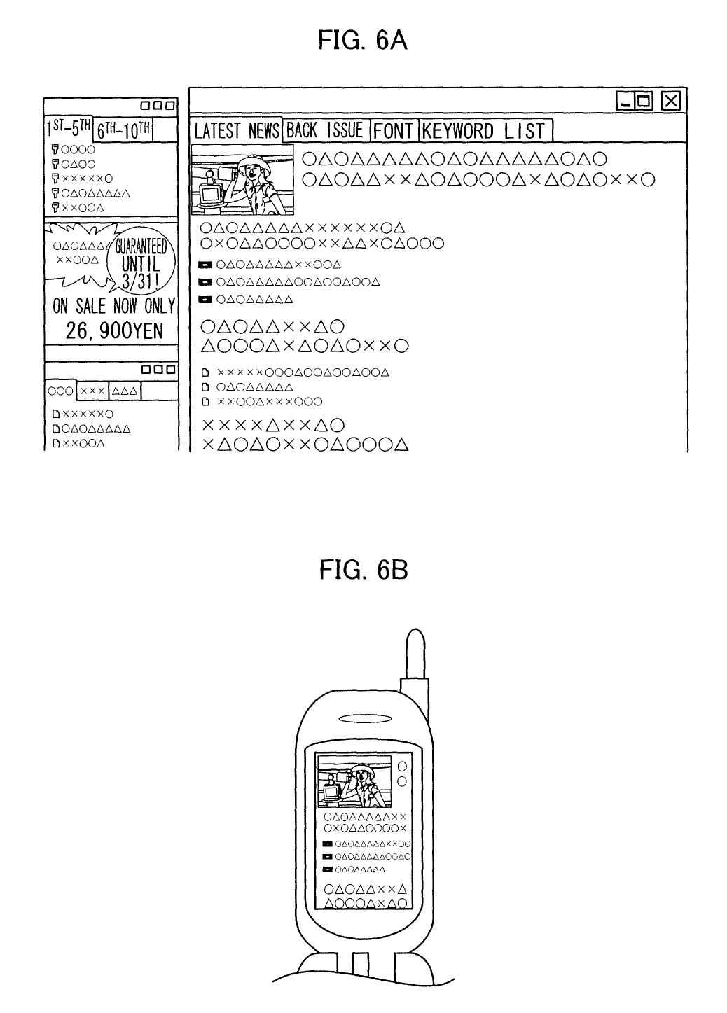

For example, when data of a webpage illustrated in FIG. 6A is acquired, a value “10” that represents the font size of the text is acquired as the size of characters of the webpage. The font size that is the most numerous among the font sizes of characters included in the webpage can be adopted as the font size of the text. In this connection, the size of characters of a webpage is not limited to the font size of the text. For example, the size of characters may be the font size of the title (for example, the largest font size among the font sizes of characters included in the webpage) or may be an average value.

The CPU 11 acquires information regarding the optimum font size for the portable terminal 20 based on the portable terminal information transmitted in step S11, the terminal information table, and the image conversion table, and outputs the acquired information to the image generation portion 14. Based on this optimum font size information and the result of rendering that has been output from the webpage analysis portion 12, the image generation portion 14 generates a browser image from the webpage that is output from the CPU 11 (step S16). More specifically, the image generation portion 14 generates a browser image by using the optimum font size as an indicator for deciding the size of the browser image.

The processing in step S16 will now be described taking as an example a case where a browser image of the webpage shown in FIG. 6A is generated in a case in which the portable terminal 20 is “keitai 1”. Based on the terminal information table shown in FIG. 2, the information relating to the display portion of “keitai 1” shows that the number of horizontal pixels is 120 pixels, the number of vertical pixels is 120 pixels, and the resolution is 75 dpi. A value “8” as the optimum font size is associated with this information relating to the display portion in the image conversion table shown in FIG. 3.

Since the font size acquired by the webpage analysis portion 12 in step S15 is 10, the image generation portion 14 converts the size of the entire webpage shown in FIG. 6A so that the font size of characters with the font size 10 becomes 8, and converts into an image the webpage obtained after the size thereof has been converted. In this manner, a browser image is generated from the webpage shown in FIG. 6A.

The link information acquisition portion 13 extracts an object that has been output from the CPU 11 and extracts a link. If the link information acquisition portion 13 has acquired an object with a fixed size such as an image or a Flash file that is included in the webpage, the image generation portion 14 changes the size of the object according to formula 1 (step S17).

### [Formula 1]

Size conversion ratio=(font size analyzed by webpage analysis portion 12)/(optimum font size)

When the font size acquired by the webpage analysis portion 12 in step S15 is 10, and the optimum font size acquired in step S16 is 8, the image generation portion 14 multiplies the size of the object by 8/10=0.8.

The link information acquisition portion 13 extracts link information from information of the webpage and the browser image. The CPU 11 acquires a compression ratio corresponding to the portable terminal 20 based on the portable terminal information that is transmitted in step S11 and the image conversion table, and uses the compression ratio to compresses the browser image generated by the image generation portion 14. The CPU 11 transmits the compressed browser image and the link information to the portable terminal 20 (step S18).

The control portion 21 outputs the browser image that has been transmitted from the server 10 to the display control portion 25. The display control portion 25 decompresses the browser image and causes the display portion 24 to display the decompressed browser image. When the browser image generated from the webpage shown in FIG. 6A is transmitted from the server 10, since the size of the browser image is greater than the size of the display portion 24, the display control portion 25 causes the display portion 24 to display the browser image in a manner such that the left upper part of the browser image matches the left upper part of the display portion 24. As a result, the webpage can be browsed on the portable terminal 20 based on the browser image and the link information that have been transmitted. Further, as shown in FIG. 6B, a browser image of a size that is easy to browse for the user that is suited to the specifications of the display portion of the portable terminal 20 is displayed.

According to the present embodiment, an image for webpage browsing can be generated that makes it possible to display a webpage in an optimum size at a portable terminal. Further, according to the present embodiment, since an image for webpage browsing of an optimum size is generated directly from a webpage, the time required to create the image can be reduced in comparison to when an image for webpage browsing is created by a method in which an image is first created based on a webpage and thereafter the image size is changed.

Furthermore, according to the present embodiment, by transmitting an image generated in an optimum size to a portable terminal from a server, since it is not necessary to transmit a needlessly large image, communication costs can be suppressed as much as possible.

Further, according to the present embodiment, since a browser image and link information are transmitted to a portable terminal, a webpage can be browsed with a portable terminal in the same manner as with a PC without requiring a special application and without creating a page for a portable terminal.

### Second Embodiment

According to the second embodiment, an optimum font size can be updated for each portable terminal or each model. A webpage browsing system 2 according to the second embodiment is described below. In the following description, components that are the same as in the first embodiment are designated by the same reference numerals, and a detailed description of such components is omitted.

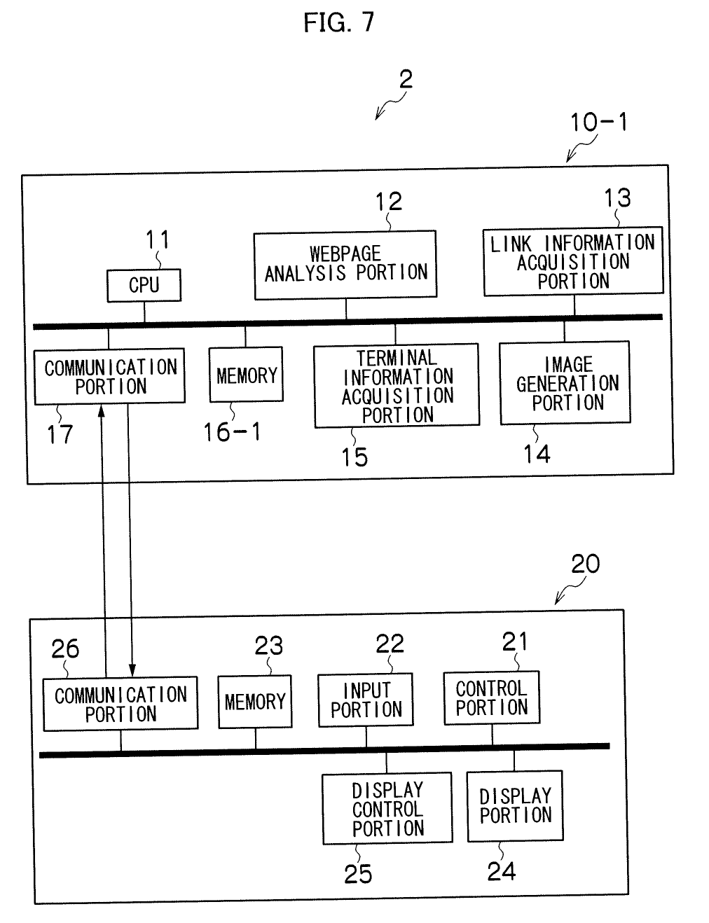

As shown in FIG. 7, the webpage browsing system 2 mainly includes a server 10-1 and a portable terminal 20. One portable terminal 20 or a plurality of portable terminals 20 may be connected to the server 10-1.

As shown in FIG. 7, the server 10-1 mainly includes a CPU 11, a webpage analysis portion 12, a link information acquisition portion 13, an image generation portion 14, a terminal information acquisition portion 15, a memory 16-1, and a communication portion 17.

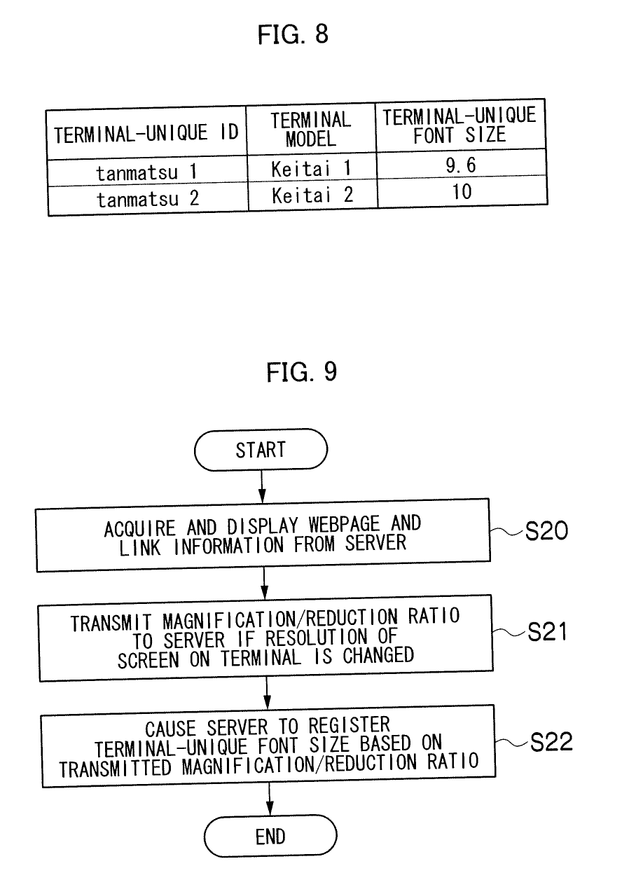

The memory 16-1 stores a terminal information table (see FIG. 2), an image conversion table (see FIG. 3), and a terminal-unique information table. As shown in FIG. 8, in the terminal-unique information table, terminal-unique IDs of portable terminals, model names of portable terminals, and terminal-unique font sizes (described in detail later) are associated and registered. The terminal-unique ID is a value that is unique to the relevant portable terminal, and a user of a portable terminal can be distinguished by a user ID.

The operations of the webpage browsing system 2 that is configured as described above will now be described. Processing by which the server 10-1 of the webpage browsing system 2 acquires portable terminal information of the portable terminal 20 is the same as the processing by which the server 10 of the webpage browsing system 1 acquires portable terminal information of the portable terminal 20 (see flow chart in FIG. 4). Hence a description thereof is omitted.

FIG. 9 is a flowchart that illustrates a flow of processing with which the server 10-1 updates the terminal-unique information table. The display control portion 25 of the portable terminal 20 causes a browser image that is transmitted from the server 10-1 in step S18 to be displayed on the display portion 24 (step S20).

The user can browse the image that is displayed on the display portion 24. The user can input an instruction to magnify or reduce the image displayed on the display portion 24 while browsing the image displayed on the display portion 24. An instruction to magnify or reduce the image is performed by inputting a ratio of magnification or reduction, that is, a magnification ratio (for example, 1.5) or a reduction ratio (for example, 0.8) using the ten-key keypad or the like of the input portion 22.

When an instruction to magnify or reduce the image is input from the input portion 22, the control portion 21 detects the instruction. The control portion 21 transmits the detected magnification ratio or reduction ratio to the server 10-1 together with the terminal-unique ID and model name of the portable terminal 20 (step S21).

The CPU 11 receives the magnification ratio or reduction ratio transmitted from the portable terminal 20 in step S21. Based on the received magnification ratio or reduction ratio and information regarding the optimum font size acquired in step S16, the CPU 11 calculates the font size of the image being displayed on the portable terminal 20 and registers the calculated font size in the terminal-unique information table (step S22).

The processing in step S22 will now be described in further detail. The CPU 11 calculates the font size of the image being displayed on the portable terminal 20 according to the following formula 2.

### [Formula 2]

Font size of image being displayed on portable terminal 20=optimum font size×magnification ratio or reduction ratio

For example, if the optimum font size acquired in step S16 is 8 and a magnification ratio of 1.2 is acquired, the CPU 11 calculates that the font size of the image being displayed on the portable terminal 20 is 9.6.

The CPU 11 takes the calculated font size to be the optimum font size (hereunder, referred to as “terminal-unique font size”) for the portable terminal 20, and associates the optimum font size with the terminal-unique ID and model name, and registers that information in the terminal-unique information table.

Thus, as shown in FIG. 8, the terminal-unique information table stored in the memory 16-1 is updated. If a terminal-unique ID has been registered in the terminal-unique information table, thereafter, when the terminal in question accesses the server 10-1, a browser image is generated based on the terminal-unique font size stored in the terminal-unique information table.

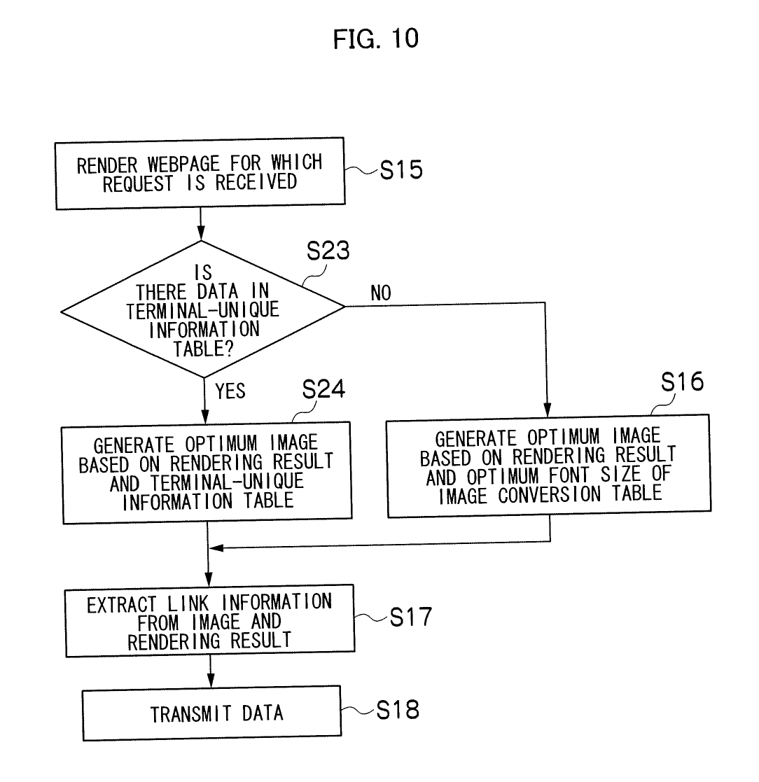

FIG. 10 is a flowchart illustrating the flow of processing by which the webpage browsing system 2 generates a browser image. This processing is performed after the CPU 11 outputs an analysis request to the webpage analysis portion 12 (step S14).

The CPU 11 acquires data of the webpage for which acquisition is requested in step S10, and outputs the data to the webpage analysis portion 12, the link information acquisition portion 13, and the image generation portion 14. The webpage analysis portion 12 performs rendering with respect to the webpage for which an acquisition request has been transmitted in step S10 (step S15).

The CPU 11 determines whether or not the portable terminal information (in this case, the terminal-unique ID) transmitted from the portable terminal 20 in step S10 is registered in the terminal-unique information table (step S23). If the terminal-unique ID is not registered in the terminal-unique information table (No in step S23), the CPU 11 generates a browser image based on the image conversion table (step S16).

If the terminal-unique ID is registered in the terminal-unique information table (Yes in step S23), the CPU 11 generates a browser image based on the terminal-unique ID transmitted in step S11 and the terminal-unique information table (step S24). More specifically, the CPU 11 acquires a terminal-unique font size that is associated with the terminal-unique ID transmitted in step S11 from the terminal-unique information table, and outputs the terminal-unique font size to the image generation portion 14. The image generation portion 14 employs the terminal-unique font size as an indicator for deciding the size of the browser image, and converts the size of the entire webpage so that the font size of the webpage that has been output from the webpage analysis portion 12 becomes the terminal-unique font size, and converts into an image the webpage whose size has been converted.

The link information acquisition portion 13 extracts an object that has been output from the CPU 11 and extracts a link. If the link information acquisition portion 13 has acquired an object with a fixed size such as an image or a Flash file that is included in the webpage, the image generation portion 14 changes the size of the object according to formula 1 (step S17).

The link information acquisition portion 13 extracts link information from information of the webpage and the browser image. The CPU 11 acquires a compression ratio corresponding to the portable terminal 20 based on the portable terminal information that is transmitted in step S11 and the image conversion table, and uses the compression ratio to compresses the browser image generated by the image generation portion 14. The CPU 11 transmits the compressed browser image and the link information to the portable terminal 20 (step S18).

It is thereby possible to generate a suitable browser image for a portable terminal whose terminal-unique ID is registered in the terminal-unique information table. Thus, the font size can be set with greater precision than when using an optimum font size that is registered for each model.

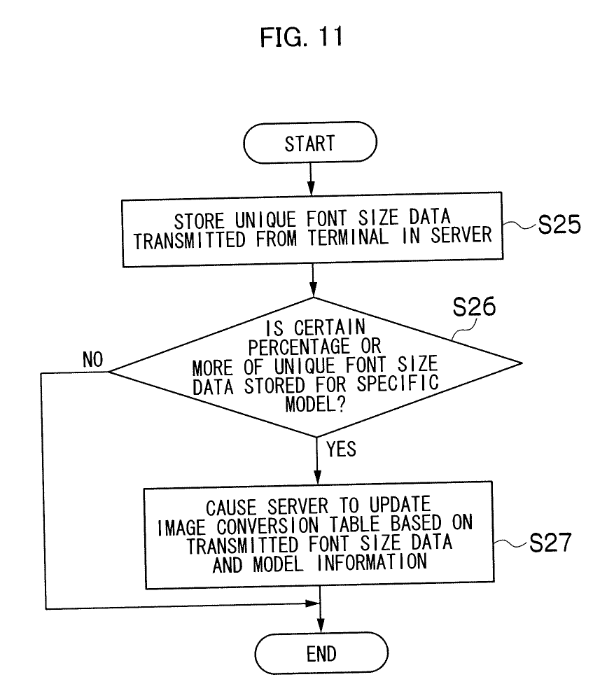

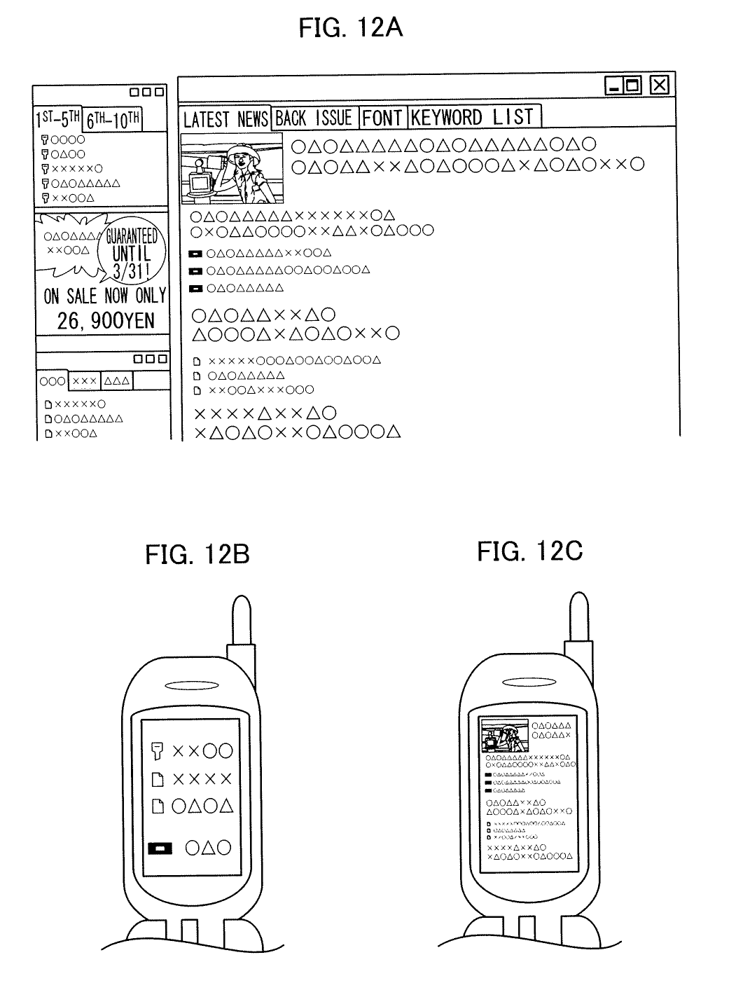

FIG. 11 is a flowchart that illustrates a flow of processing with which the server 10-1 updates the image conversion table. This processing is started after the terminal-unique ID, model name, and magnification ratio or reduction ratio are transmitted to the server 10 from the portable terminal 20 (step S21).

The CPU 11 receives the model name and magnification ratio or reduction ratio that are transmitted from the portable terminal 20 in step S21, and associates these items and stores the associated information in the memory 16 (step S25). Hereunder, a table in which model names and magnification ratios or reduction ratios are associated and stored is referred to as a “model information table”.

The CPU 11 determines whether or not a certain percentage or more (for example, 10%) of data of the same model is registered in the model information table (step S26). For example, if 100 items of data for the model name “keitai 1” are registered in the model information table, the CPU 11 determines whether or not 10 items or more of data with respect to which the same magnification ratio or reduction ratio is associated are registered for the model name “keitai 1” in the model information table.

If a certain percentage or more of data of the same model is not registered in the model information table (No in step S26), the CPU 11 ends the processing. In contrast, if a certain percentage or more of data of the same model is registered in the model information table (Yes in step S26), the CPU 11 updates the image conversion table based on the contents registered in the model information table (step S27).

The processing in step S27 will now be described using a specific example. It is assumed that in step S26, 10 items or more of data in which a magnification ratio of 1.2 is associated with the model name “keitai 1” are registered. The CPU 11 refers to the terminal information table and acquires information relating to the display portion of the portable terminal that corresponds to that model name. In the terminal information table shown in FIG. 2, the information that is associated with the model name “keitai 1” shows that the number of horizontal pixels is 120 pixels, the number of vertical pixels is 120 pixels, and the resolution is 75 dpi.

The CPU 11 calculates the optimum font size that should be updated to according to formula 3. For example, when the optimum font size before updating that is acquired in step S16 is 8 and a magnification ratio of 1.2 has been acquired, the CPU 11 calculates that the font size of the image that is being displayed on the portable terminal 20 is 9.6.

### [Formula 3]

Optimum font size that should be updated to=optimum font size before updating×magnification ratio or reduction ratio

The CPU 11 then changes the optimum font size associated with the information relating to the display portion of the portable terminal corresponding to the model name in the image conversion table so as to become the optimum font size that should be updated to. Since the information associated with the model name “keitai 1” is number of horizontal pixels=120 pixels, number of vertical pixels=120 pixels, and resolution=75 dpi, the CPU 11 changes the optimum font size “8” that is associated with the information for number of horizontal pixels=120 pixels, the number of vertical pixels=120 pixels, and resolution=75 dpi, to “9.6” as the optimum font size that should be updated to.

The image conversion table is thereby updated. Accordingly, when generating a browser image thereafter, since the browser image is generated based on the optimum font size registered in the image conversion table after updating, a browser image that is appropriate for the model in question can be generated.

According to the present embodiment, an indicator (terminal-unique font size, optimum font size or the like) that indicates an optimum size of a browser image can be updated. Consequently, a browser image of an optimum size can be generated for each model and each user.

In this connection, although according to the present embodiment, terminal-unique IDs, model names, and terminal-unique font sizes are associated and registered in the terminal-unique information table, association with a terminal-unique font size is not limited to a terminal-unique ID. For example, a user ID (for example, uid), a model name, and a terminal-unique font size may be associated and stored. In this case, a configuration may be adopted in which a user ID is transmitted in step S21. Further, a model name is not necessarily required for the terminal-unique information table, and the model name may be omitted therefrom.

Although according to the present embodiment the terminal-unique information table or the image conversion table is updated when a magnification ratio or reduction ratio is input, a configuration may also be adopted in which the terminal-unique information table or the image conversion table is updated only when a magnification ratio or reduction ratio is input and confirmation of the magnification ratio or reduction ratio is input via the input portion 22.

Further, although according to the present embodiment the image conversion table is updated based on contents registered in the model information table when a certain percentage or more of data of the same model is registered in the model information table (Yes in step S26), a criterion for determining whether or not to update the image conversion table based on contents registered in the model information table is not limited thereto. For example, a configuration may be adopted in which the image conversion table is updated based on contents registered in the model information table when a predetermined number or more of data items for the same model have been registered.

Furthermore, although according to the present embodiment a magnification ratio or reduction ratio is input from the input portion 22 as an instruction for magnification or reduction of an image, an instruction for magnification or reduction of an image is not limited to a case where a magnification ratio or reduction ratio is input. For example, an instruction for magnification or reduction may be input by means of the input portion 22. In this case, the particular ratios to be used to perform magnification or reduction (magnification ratio or reduction ratio) in accordance with specific magnification or reduction instructions may be stored separately, and the font size of an image being displayed on the portable terminal 20 may be calculated using the relevant ratio. Further, a configuration may be adopted which changes the magnification ratio or reduction ratio according to the number of times that a magnification or reduction instruction has been input.

Although a system that includes a server and a portable terminal is described as an example according to the foregoing first and second embodiments, the present invention is not limited to a system, and can also be provided as a server that distributes an image to an external apparatus. The present invention can also be provided as a program that is applied to a server. Further, a portable terminal is not limited to a mobile phone, and the present invention can be applied to various portable devices.

What is claimed is:

1. A webpage browsing system comprising a portable terminal which includes a display device, and a server which is connected to the portable terminal, wherein:
the portable terminal comprises:
a terminal-side transmission device which transmits information relating to the portable terminal to the server,
a terminal-side reception device which receives an image that is transmitted from the server, and
a display control device which causes the display device to display the image that is received by the terminal-side reception device;
and the server comprises:
an acquisition device which acquires a webpage;
an analyzing device which analyzes the webpage that is acquired by the acquisition device;
a server-side reception device which receives the information relating to the portable terminal that is transmitted by the terminal-side transmission device;
a storage device in which information relating to the portable terminal and an indicator that indicates a size of an optimum image are associated and stored;
an image generation device which generates an image from the webpage acquired by the acquisition device based on an analysis result produced by the analyzing device, the information relating to the portable terminal that is received by the server-side reception device, and the information relating to the portable terminal and the indicator indicating a size of an optimum image that are associated and stored in the storage device; and
a server-side transmission device which transmits the image generated by the image generation device to the portable terminal.

2. The webpage browsing system according to claim 1, wherein:
the portable terminal further comprises an input device which, when a size of an image displayed by the display device is not appropriate, accepts input of a ratio of magnification or reduction of the size of the displayed image;
the terminal-side transmission device transmits the ratio of magnification or reduction that is input by the input device to the server;
the server-side reception device receives the ratio of magnification or reduction that is transmitted from the terminal-side transmission device; and
the server further comprises an updating device which updates the indicator that indicates a size of an optimum image that is stored in the storage device based on the ratio of magnification or reduction that is received by the server-side reception device.

3. The webpage browsing system according to claim 2, wherein:
the storage device associates and stores the ratio of magnification or reduction that is transmitted from the terminal-side transmission device and the information relating to the portable terminal; and
when the ratio of magnification or reduction and the information relating to the portable terminal that are associated and stored in the storage device satisfy a predetermined criterion, the updating device updates the indicator that indicates a size of an optimum image that is stored in the storage device.

4. The webpage browsing system according to claim 1, wherein:
the terminal-side transmission device transmits information showing a model of the portable terminal or information that is unique to the portable terminal as the information relating to the portable terminal;
the server-side reception device receives the information showing the model of the portable terminal or the information that is unique to the portable terminal that is transmitted by the terminal-side transmission device;
the storage device associates and stores information showing the model of the portable terminal or information that is unique to the portable terminal and a size of characters (hereunder, referred to as “appropriate font size”) in an image that is displayed in an optimum size by the portable terminal;
the analyzing device acquires a font size of the acquired webpage; and
the image generation device comprises:
a device which acquires an appropriate font size with respect to the portable terminal based on the information showing the model of the portable terminal or the information that is unique to the portable terminal that is received by the server-side reception device, and the information showing the model of the portable terminal or the information that is unique to the portable terminal that is stored in the storage device,
a device which converts a size of the webpage so that the font size acquired by the analyzing device becomes the appropriate font size with respect to the portable terminal, and
a device which converts the webpage, whose size has been converted, to generate an image.

5. The webpage browsing system according to claim 3, wherein:
the terminal-side transmission device transmits information showing a model of the portable terminal or information that is unique to the portable terminal as the information relating to the portable terminal;
the server-side reception device receives the information showing the model of the portable terminal or the information that is unique to the portable terminal that is transmitted by the terminal-side transmission device;
the storage device associates and stores information showing the model of the portable terminal or information that is unique to the portable terminal and a size of characters (hereunder, referred to as “appropriate font size”) in an image that is displayed in an optimum size by the portable terminal;
the analyzing device acquires a font size of the acquired webpage; and
the image generation device comprises:
a device which acquires an appropriate font size with respect to the portable terminal based on the information showing the model of the portable terminal or the information that is unique to the portable terminal that is received by the server-side reception device, and the information showing the model of the portable terminal or the information that is unique to the portable terminal that is stored in the storage device,
a device which converts a size of the webpage so that the font size acquired by the analyzing device becomes the appropriate font size with respect to the portable terminal, and
a device which converts the webpage, whose size has been converted, to generate an image.

6. The webpage browsing system according to claim 4, wherein:
the analyzing device analyzes whether or not an object is included in the webpage; and
the server further comprises:
a link information extraction device which, when a result of analysis by the analyzing device indicates that an object is included, extracts link information to the object; and
a size conversion ratio calculation device which calculates a size conversion ratio based on the font size acquired by the analyzing device and the appropriate font size for the portable terminal;
wherein:
the server-side transmission device transmits the image generated by the image generation device, the link information extracted by the link information extraction device, and the size conversion ratio calculated by the size conversion ratio calculation device to the portable terminal, and
the display control device causes the object to be displayed in an optimum size overlapping the image based on the link information and the size conversion ratio.

7. The webpage browsing system according to claim 5, wherein:
the analyzing device analyzes whether or not an object is included in the webpage; and
the server further comprises:
a link information extraction device which, when a result of analysis by the analyzing device indicates that an object is included, extracts link information to the object; and
a size conversion ratio calculation device which calculates a size conversion ratio based on the font size acquired by the analyzing device and the appropriate font size for the portable terminal;
wherein:
the server-side transmission device transmits the image generated by the image generation device, the link information extracted by the link information extraction device, and the size conversion ratio calculated by the size conversion ratio calculation device to the portable terminal, and
the display control device causes the object to be displayed in an optimum size overlapping the image based on the link information and the size conversion ratio.

8. The webpage browsing system according to claim 1, wherein:
the storage device associates and stores information relating to the portable terminal, an indicator that indicates a size of an optimum image, and a compression ratio of an image with respect to the portable terminal;
the server further comprises a compression device which acquires the compression ratio based on the information relating to the portable terminal that is received by the server-side reception device, and compresses the image generated by the image generation device using the compression ratio; and
the server-side transmission device transmits the image that is compressed by the compression device.

9. The webpage browsing system according to claim 7, wherein:
the storage device associates and stores information relating to the portable terminal, an indicator that indicates a size of an optimum image, and a compression ratio of an image with respect to the portable terminal;
the server further comprises a compression device which acquires the compression ratio based on the information relating to the portable terminal that is received by the server-side reception device, and compresses the image generated by the image generation device using the compression ratio; and
the server-side transmission device transmits the image that is compressed by the compression device.

10. A server that comprises a webpage browsing system according to claim 1.

11. A server that comprises a webpage browsing system according to claim 9.

12. A webpage browsing method, comprising:
a step of receiving information relating to a portable terminal from the portable terminal;
a step of acquiring an indicator that indicates a size of an optimum image with respect to the portable terminal based on the received information relating to the portable terminal and information relating to a portable terminal and an indicator that indicates a size of an optimum image that are associated and stored in a storage device;
a step of acquiring a webpage;
a step of analyzing the acquired webpage;
a step of generating an image from the acquired webpage based on a result of analysis of the webpage and the acquired indicator that indicates a size of an optimum image with respect to the portable terminal; and
a step of transmitting the generated image to the portable terminal.

13. A program which causes an arithmetic apparatus to execute a webpage browsing method according to claim 12.

14. A recording medium in which code of the program according to claim 13 is stored, wherein the code is readable by the arithmetic apparatus.
